(19) United States
(12) Patent Application Publication
(10) Pub. No.: US 2023/0112812 A1
(43) Pub. Date: Apr. 13, 2023

(54) DATA PROCESSING METHOD AND DATA PROCESSING SYSTEM

(71) Applicant: SHIMADZU CORPORATION, Kyoto (JP)

(72) Inventors: Yuichiro FUJITA, Kyoto (JP); Akira NISHIO, Kyoto (JP)

(21) Appl. No.: 17/894,252

(22) Filed: Aug. 24, 2022

(30) Foreign Application Priority Data
Sep. 27, 2021 (JP) 2021-156830

(51) Int. Cl. G01N 30/86

(52) U.S. Cl. CPC G01N 30/8675; G01N 30/8631; G01N 30/8651; G01N 2030/862

(57) ABSTRACT

A data processing method for separating peaks of a plurality of components overlapping on a chromatogram from each other using actual data of a three-dimensional chromatogram including a chromatogram and a spectrum acquired by chromatographic analysis on a sample. The data processing method includes an adjustment target peak acquisition step of obtaining a plurality of adjustment target peaks by applying, to the chromatogram, a peak model function prepared in advance to approximate a waveform of the chromatogram, and an adjustment target peak adjustment step of setting a plurality of the adjustment target peaks obtained in the adjustment target peak acquisition step as initial values before adjustment, and repeating adjustment of the adjustment target peaks until pseudo data of a three-dimensional chromatogram on the sample obtained by combining the adjustment target peaks after adjustment is similar to the actual data.

### BACKGROUND OF THE INVENTION

### 1. Field of the Invention

The present invention relates to a data processing method and a data processing system using three-dimensional chromatogram data.

### 2. Description of the Related Art

In a liquid chromatograph (LC) using a multichannel detector such as a photodiode array (PDA) detector, three-dimensional chromatogram data having three dimensions of time, wavelength, and signal intensity (absorbance) can be obtained by continuously acquiring an absorption spectrum of a sample eluted from an analysis column.

In a case where a target component in a sample is quantified using a liquid chromatograph, in general, a chromatogram is created using a wavelength at which the absorbance of the target component is the largest, and an area value of a peak of the target component is obtained on the chromatogram to perform quantification. However, a sample may contain an impurity other than the target component, and a peak of the impurity may overlap a peak of the target component on the chromatogram. In such a case, it is not possible to obtain a peak area value of the target component or the impurity if a plurality of peaks overlap each other, and a quantification result cannot be obtained. For this reason, it is necessary to separate a plurality of components whose peaks overlap each other on the chromatogram from each other.

As an algorithm (referred to as a peak separation algorithm) for separating a plurality of peaks overlapping each other, an algorithm for estimating a chromatogram and a spectrum of each of a plurality of components having peaks overlapping each other by applying a peak model function such as an exponential modified gaussian (EMG) function to a waveform of an actual chromatogram is known (see WO 2016/035167 A).

### SUMMARY OF THE INVENTION

There is a peak separation algorithm by applying a peak model function (hereinafter, referred to as a model-using algorithm) that uses an improved EMG function capable of expressing tailing and leading of an actual peak waveform, and can reproduce a waveform shape of an actual chromatogram with high accuracy by the improved EMG function, and as a result, quantification of each component can be performed with high accuracy. However, in a case where peaks of a plurality of components having an extremely large relative concentration ratio in a sample, such as 100:0.05, overlap each other on a chromatogram, when the peaks are separated by applying the model-using algorithm, it has been found that a phenomenon in which a peak area value of a component having low concentration is greatly different from an actual peak area value occurs.

The present invention has been made in view of the above problem, and an object of the present invention is to enable quantification of a component having a relatively low concentration to be performed with high accuracy even in a case where peaks of a plurality of components having an extremely large relative concentration ratio in a sample overlap each other on a chromatogram.

In the model-using algorithm, a peak model function prepared in advance is applied to a waveform of an actual chromatogram while a parameter (for example, height, spread) of the function is adjusted, so that shapes and sizes of a plurality of peaks overlapping each other on the chromatogram are estimated. For this reason, the estimated peak shape of each component is restricted by the peak model function. Therefore, a slight deviation occurs between an area value of each peak replaced by the peak model function and an actual area value of each peak. This is considered to be a cause of deterioration in quantification accuracy of a component having a relatively low concentration when peaks of a plurality of components having an extremely large relative concentration ratio, such as 100:0.05, are separated and quantified.

Meanwhile, in the peak separation algorithm, there is also an algorithm that does not use a peak model function (hereinafter, referred to as a model-free algorithm). Typical examples of the model-free algorithm include one using matrix decomposition such as non-negative matrix factorization (NMF). The model-free algorithm using matrix decomposition is an algorithm in which an original three-dimensional chromatogram is separated into a designated number of peaks by a mathematical method, and each of the separated peaks is finely adjusted so that a pseudo three-dimensional chromatogram obtained by combining each of the separated peaks approximates the original three-dimensional chromatogram. In such a model-free algorithm, since a peak shape after separation is not restricted by a peak model function, the degree of freedom of separation of peaks is high, and it is possible to bring a pseudo three-dimensional chromatogram obtained by combining each of separated peaks close to an original three-dimensional chromatogram as much as possible. On the other hand, since there is no information on a peak shape after separation in exchange for no restriction by a peak model function, a shape of each separated peak may be completely different from an actual peak shape. For this reason, reproducibility of a peak separation result by the model-free algorithm is often worse than that of a peak separation result by the model-using algorithm.

The inventors of the present application have focused on high degree of freedom of peak separation of the model-free algorithm, and have reached an idea of complementing the model-using algorithm with the model-free algorithm. Then, the inventors of the present application have found that when fine adjustment is performed by the model-free algorithm with a separation result of peaks obtained using the model-using algorithm as initial data, excellent separation accuracy is obtained even in a case where peaks of a plurality of components having an extremely large relative concentration ratio such as 100:0.05 overlap each other. The present invention has been made based on such a finding.

A data processing method according to the present invention is a data processing method for separating peaks of a plurality of components overlapping on a chromatogram from each other using actual data of a three-dimensional chromatogram including a chromatogram and a spectrum acquired by chromatographic analysis on a sample. The data processing method includes an adjustment target peak acquisition step of obtaining a plurality of adjustment target peaks by applying, to the chromatogram, a peak model function prepared in advance to approximate a waveform of the chromatogram, an estimation data creation step of creating estimation data of a chromatogram and a spectrum on each of a plurality of the components by combining a plurality of the adjustment target peaks obtained in the adjustment target peak acquisition step, and an adjustment target peak adjustment step of setting the estimation data created in the estimation data creation step as an initial value before adjustment, and repeating adjustment of the adjustment target peaks until pseudo data of a three-dimensional chromatogram on the sample obtained by combining the adjustment target peaks after adjustment is similar to the actual data.

A data processing system according to the present invention includes a storage part that stores actual data of a three-dimensional chromatogram including a chromatogram and a spectrum acquired by chromatographic analysis on a sample, and a peak model function prepared in advance, and a data processor configured to perform processing of actual data of the three-dimensional chromatogram using a the peak model function and processing of separating peaks of a plurality of components overlapping on the chromatogram from each other. The data processor is configured to execute an adjustment target peak acquisition step of obtaining a plurality of adjustment target peaks by applying a the peak model function stored in the storage part to the chromatogram, and an adjustment target peak adjustment step of setting the adjustment target peak obtained in the adjustment target peak acquisition step as an initial value before adjustment, and repeating adjustment of the adjustment target peak until pseudo data of a three-dimensional chromatogram for the sample obtained by combining the adjustment target peaks after adjustment is similar to the actual data.

That is, in the data processing method and the data processing system according to the present invention, first, an adjustment target peak estimated as a peak of each of a plurality of components overlapping each other on a chromatogram is acquired using the model-using algorithm. Since the adjustment target peak is restricted by a peak model function, the adjustment target peak does not completely match an actual peak of each component, but is considered to approximate the actual peak to some extent. An adjustment target peak having such a certain degree of approximation is acquired, and adjustment by the model-free algorithm, that is, adjustment without restriction of a peak model function is performed using the adjustment target peak as initial data before adjustment. When an attempt is made to separate each peak of a plurality of components from actual data of a three-dimensional chromatogram using the model-free algorithm from the beginning, separation of peaks is performed in a state where there is no information on a peak shape of each component, and thus it is difficult to obtain an appropriate estimation result. On the other hand, when the model-free algorithm is performed using an adjustment target peak having a certain degree of approximation as initial data, fine adjustment is performed such that the adjustment target peak approaches actual data, and the degree of approximation of estimation data with respect to the actual data is improved.

According to the data processing method and the data processing system of the present invention, after an adjustment target peak of each of a plurality of components overlapping each other on a chromatogram is acquired using the model-using algorithm, the adjustment target peak acquired by the model-using algorithm is adjusted by the model-free algorithm. Therefore, fine adjustment is performed such that the adjustment target peak approaches actual data, and the degree of approximation of estimation data to the actual data is improved. As a result, even when peaks of a plurality of components having an extremely large relative concentration ratio in a sample overlap each other on a chromatogram, a component having a relatively low concentration can be quantified with high accuracy.

### BRIEF DESCRIPTION OF THE DRAWINGS

FIG. 1 is a block diagram schematically illustrating an embodiment of a data processing system;

FIG. 2 is a flowchart schematically illustrating a data processing method performed by the data processing system of the embodiment;

FIG. 3 is a flowchart illustrating a specific example of the data processing method;

FIG. 4 is a diagram illustrating an example of application of a peak model function in a peak model-using algorithm, in which (A) shows a chromatogram at a certain wavelength of actual data, and (B) shows a state in which the peak model function is applied to the chromatogram; and

FIG. 5 is a diagram illustrating a separation process of a peak in the data processing method, in which (A) shows a chromatogram at a certain wavelength of actual data, (B) shows estimation data of a chromatogram of each component separated by a peak model-using algorithm, and (C) shows estimation data of a chromatogram of each component adjusted by matrix decomposition.

### DETAILED DESCRIPTION OF THE INVENTION

Hereinafter, an embodiment of a data processing method and a data processing system of a chromatogram according to the present invention will be described with reference to the drawings.

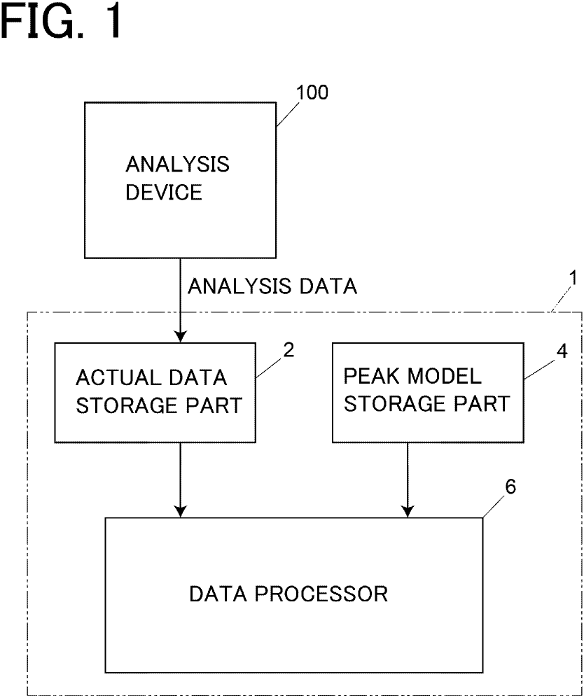

FIG. 1 illustrates an embodiment of the data processing system.

A data processing system 1 includes an actual data storage part 2, a peak model storage part 4, and a data processor 6. Analysis data acquired by an analysis device 100 is taken into the data processing system 1. The analysis device 100 is configured to perform liquid chromatography analysis on a sample to acquire an absorbance spectrum at regular time intervals. That is, the analysis data taken into the data processing system 1 from the analysis device 100 is data of a three-dimensional chromatogram including a chromatogram and a spectrum. Hereinafter, data of a three-dimensional chromatogram taken into the analysis system 1 from the analysis device 100 is referred to as “actual data”.

The actual data storage part 2 is a storage area for storing actual data of a three-dimensional chromatogram taken in from the analysis device 100. The actual data storage part 2 can be realized by a non-volatile flash memory, a hard disk drive, or the like.

The peak model storage part 4 stores a peak model function prepared in advance. Examples of the peak model function include a model based on an improved EMG function including a combination of a Gaussian function and an exponential function configured to reproduce a peak waveform having tailing and leading like an actual peak waveform appearing in a chromatogram. Similarly to the actual data storage part 2, the peak model storage part 4 can be realized by a non-volatile flash memory, a hard disk drive, or the like, but can also be realized by a database provided on a network.

The data processor 6 processes actual data of a three-dimensional chromatogram stored in the actual data storage part 2. The processing of actual data by the data processor 6 includes, in addition to quantification processing of quantifying concentration of a component contained in a sample from an area value of a peak on a chromatogram of the actual data, peak separation processing of separating peaks of a plurality of components from each other when the peaks overlap each other on a chromatogram of the actual data. The data processor 6 is a function realized by a program executed in a computer circuit including a central processor (CPU).

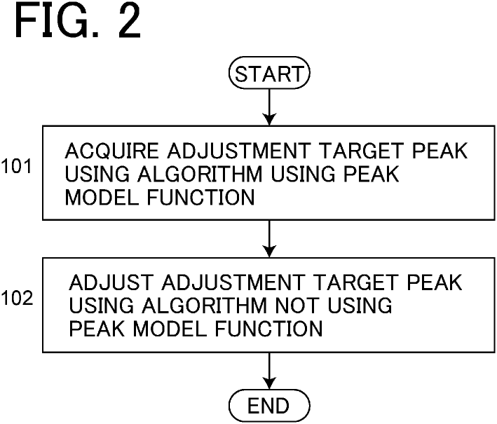

As illustrated in FIG. 2, the peak separation processing by the data processor 6 includes a first process (Step 101) of creating estimation data of a chromatogram and a spectrum of each of a plurality of components having peaks overlapping each other by using an algorithm using a peak model function (model-using algorithm), and a second process (Step 102) of adjusting estimation data by using an algorithm not using a peak model function (model-non-using algorithm). The model-using algorithm used in the first process may be known, and examples of the model-using algorithm include one disclosed in WO 2016/035167 A. The peak model-non-using algorithm used in the second process may also be known, and examples of the peak model-non-using algorithm include one using matrix decomposition such as non-negative matrix factorization (NMF).

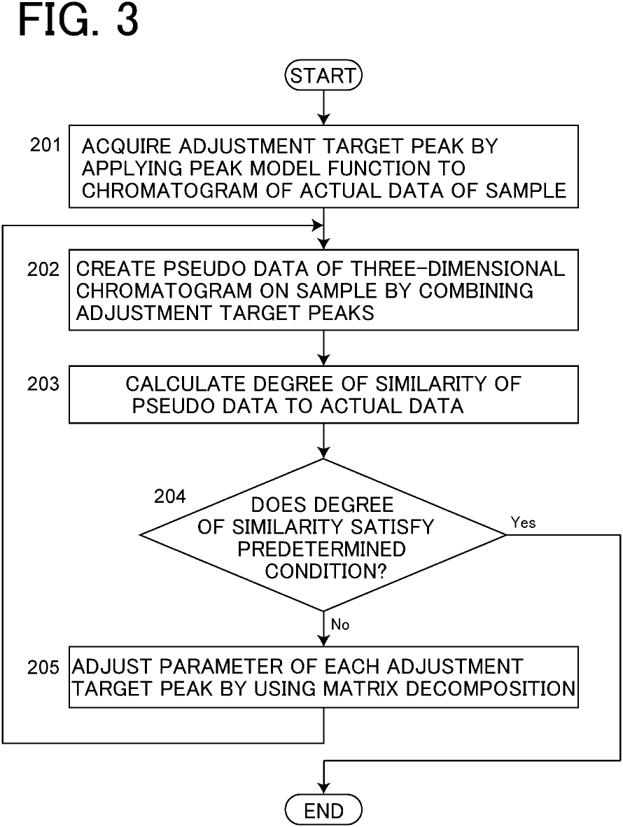

A more specific procedure of the peak separation processing is shown in FIG. 3.

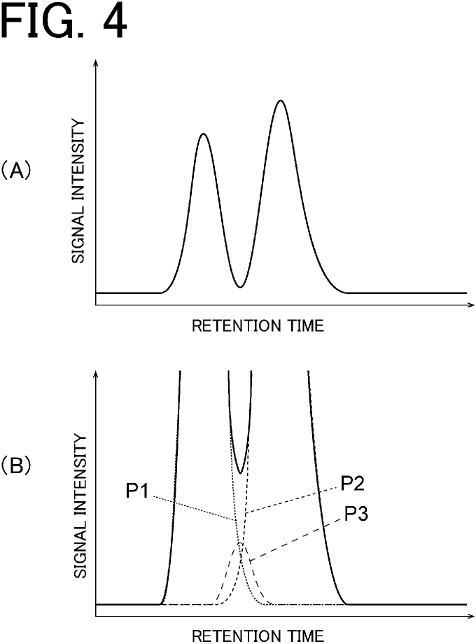

When the peak separation processing is started, the data processor 6 first applies a peak model function to a chromatogram of actual data while adjusting a parameter (height, spread, and the like) of the peak model function, and acquires the applied peak model function as an adjustment target peak (Step 201). For example, when a waveform of a chromatogram at a certain wavelength in actual data is as shown in FIG. 4(A), as shown in FIG. 4(B), a waveform of the chromatogram is approximated by three peak model functions with an adjusted parameter. Each peak model function applied to approximate a waveform of a chromatogram is an adjustment target peak. This Step 201 is the first process using the model-using algorithm.

The data processor 6 combines the adjustment target peaks acquired in Step 201 to create pseudo data of a three-dimensional chromatogram for a sample (Step 202), and calculates degree of similarity of the pseudo data of the three-dimensional chromatogram to the actual data (Step 203). The “degree of similarity” only needs to be a numerical value indicating how similar the pseudo data is to the actual data. For this reason, a method of calculating the degree off similarity is not particularly limited, but for example, a total value of squares of differences between a numerical value of the pseudo data and a numerical value of the actual data at each point of the three-dimensional chromatogram can be used as the degree of similarity.

The data processor 6 adjusts a parameter of the adjustment target peak using matrix decomposition so that the obtained degree of similarity is improved, that is, the pseudo data is closer to the actual data (Step 205). After the above, the data processor 6 combines the adjustment target peaks after adjustment to create pseudo data of the three-dimensional chromatogram (Step 202), and evaluates the degree of similarity of the created pseudo data to the actual data (Steps 203 and 204). In this way, Steps 202 to 205 are repeated, and when the degree of similarity of the pseudo data to the actual data satisfies a predetermined condition, the peak separation processing ends (Step 206: Yes). Examples of the predetermined condition include that the degree of similarity falls below (or exceeds) a preset threshold, or that the degree of similarity to the actual data of the pseudo data obtained by combining the adjustment target peaks after adjustment converges to a certain value.

Steps 202 to 205 described above are the second process using the model-non-using algorithm. In the second process, each peak separated in the first process is adjusted without restriction on a shape by a peak model function. As a result, a portion where actual data cannot be approximated enough in the first process due to restriction of a peak model function is adjusted, and the size and shape of a peak of each component after separation approach actual ones.

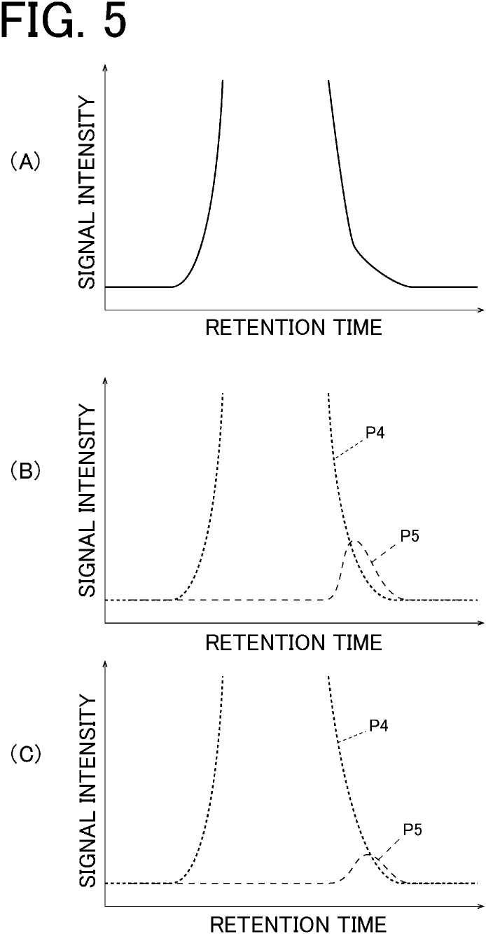

FIG. 5 shows an example of a peak separation state in each process of the peak separation processing.

FIG. 5(A) is a part of a waveform of a chromatogram at a certain wavelength of actual data before the peak separation processing is executed. When the first process by the model-using algorithm is performed on actual data having this chromatogram, two peak model functions are applied to obtain two adjustment target peaks P4 and P5 as illustrated in FIG. 5(B). Then, when the second process by the model-non-using algorithm is performed using the obtained adjustment target peak as initial data before adjustment, the shapes and sizes of the adjustment target peaks P4 and P5 are adjusted as illustrated in FIG. 5(C).

As described above, when only the model-using algorithm is used, that is, when only the first process is performed to separate peaks of two components having an extremely large component relative concentration ratio of 100:0.05, a peak area of a component having a relatively low concentration may be twice or more an actual peak area. On the other hand, the present inventors have confirmed that when the second process using the model-non-using algorithm is performed using a peak separation result obtained in the first process as initial data before adjustment, the shapes and sizes of peaks of the two components are adjusted, and as a result, the peak area of the component having a relatively low concentration approaches the actual peak area.

The embodiment described above merely illustrates an embodiment of the data processing method and the data processing system according to the present invention. The embodiment of the data processing method and the data processing system according to the present invention is as described below.

An embodiment of the data processing method according to the present invention is a data processing method for separating peaks of a plurality of components overlapping on a chromatogram from each other using actual data of a three-dimensional chromatogram including a chromatogram and a spectrum acquired by chromatographic analysis on a sample. The data processing method includes an adjustment target peak acquisition step of obtaining a plurality of adjustment target peaks by applying, to the chromatogram, a peak model function prepared in advance to approximate a waveform of the chromatogram, an estimation data creation step of creating estimation data of a chromatogram and a spectrum on each of a plurality of the components by combining a plurality of the adjustment target peaks obtained in the adjustment target peak acquisition step, and an adjustment target peak adjustment step of setting the estimation data created in the estimation data creation step as an initial value before adjustment, and repeating adjustment of the adjustment target peaks until pseudo data of a three-dimensional chromatogram on the sample obtained by combining the adjustment target peaks after adjustment is similar to the actual data.

In a first aspect of the embodiment of the data processing method, a function obtained by combining a Gaussian function and an exponential function is used as the peak model function. According to such an aspect, it is possible to use a peak model function in consideration of tailing and leading of an actual peak, and to approximate an estimated shape of a peak after separation to an actual shape.

In a second aspect of the embodiment of the data processing method, in the adjustment target peak adjustment step, the adjustment is performed using matrix decomposition. This second aspect can be combined with the first aspect.

As the matrix decomposition, non-negative matrix factorization can be used.

In a third aspect of the embodiment of the data processing method, in the adjustment target peak adjustment step, degree of similarity between the pseudo data obtained by combining the adjustment target peaks after adjustment and the actual data is calculated, and when the degree of similarity satisfies a preset criterion or when the degree of similarity converges to a certain value, the pseudo data is determined to be similar to the actual data, and the adjustment is finished. This third aspect can be combined with the first aspect and/or the second aspect.

An embodiment of the data processing system according to the present invention includes a storage part that stores actual data of a three-dimensional chromatogram including a chromatogram and a spectrum acquired by chromatographic analysis on a sample, and a peak model function prepared in advance, and a data processor configured to perform processing of actual data of the three-dimensional chromatogram using the peak model function and processing of separating peaks of a plurality of components overlapping on the chromatogram from each other. The data processor is configured to execute an adjustment target peak acquisition step of obtaining a plurality of adjustment target peaks by applying the peak model function stored in the storage part to the chromatogram, and an adjustment target peak adjustment step of setting the adjustment target peak obtained in the adjustment target peak acquisition step as an initial value before adjustment, and repeating adjustment of the adjustment target peak until pseudo data of a three-dimensional chromatogram for the sample obtained by combining the adjustment target peaks after adjustment is similar to the actual data.

In a first aspect of the embodiment of the data processing system, the data processor is configured to use a function obtained by combining a Gaussian function and an exponential function as the peak model function. According to such an aspect, it is possible to use a peak model function in consideration of tailing and leading of an actual peak, and to approximate an estimated shape of a peak after separation to an actual shape.

In a second aspect of the embodiment of the data processing system, the data processor performs the adjustment using matrix decomposition in the adjustment target peak adjustment step. This second aspect can be combined with the first aspect.

As the matrix decomposition, non-negative matrix factorization can be used.

In a third aspect of the embodiment of the data processing system, in the adjustment target peak adjustment step, the data processor is configured to calculate degree of similarity between the pseudo data obtained by combining the adjustment target peaks after adjustment and the actual data, and end the adjustment when the degree of similarity satisfies a preset criterion or when the degree of similarity converges to a certain value. This third aspect can be combined with the first aspect and/or the second aspect.

### Description of Reference Signs

1 data processing system
2 actual data storage part
4 peak model storage part
6 data processor
100 analysis device

What is claimed is:

1. A data processing method for separating peaks of a plurality of components overlapping on a chromatogram from each other using actual data of a three-dimensional chromatogram including a chromatogram and a spectrum acquired by chromatographic analysis on a sample, the data processing method comprising:
an adjustment target peak acquisition step of obtaining a plurality of adjustment target peaks by applying, to the chromatogram, a peak model function prepared in advance to approximate a waveform of the chromatogram; and
an adjustment target peak adjustment step of setting the plurality of adjustment target peaks obtained in the adjustment target peak acquisition step as initial values before adjustment, and repeating adjustment of the adjustment target peaks until pseudo data of a three-dimensional chromatogram on the sample obtained by combining the adjustment target peaks after adjustment is similar to the actual data.

2. The data processing method according to claim 1, wherein a function obtained by combining a Gaussian function and an exponential function is used as the peak model function.

3. The data processing method according to claim 1, wherein in the adjustment target peak adjustment step, the adjustment is performed using matrix decomposition.

4. The data processing method according to claim 3, wherein the matrix decomposition is non-negative matrix factorization.

5. The data processing method according to claim 1, wherein in the adjustment target peak adjustment step, degree of similarity between the pseudo data obtained by combining the adjustment target peaks after adjustment and the actual data is calculated, and when the degree of similarity satisfies a preset criterion or when the degree of similarity converges to a certain value, the pseudo data is determined to be similar to the actual data, and the adjustment is finished.

6. A data processing system comprising:
a storage part that stores actual data of a three-dimensional chromatogram including a chromatogram and a spectrum acquired by chromatographic analysis on a sample, and a peak model function prepared in advance; and
a data processor configured to perform processing of actual data of the three-dimensional chromatogram using the peak model function and processing of separating peaks of a plurality of components overlapping on the chromatogram from each other,
wherein the data processor is configured to execute:
an adjustment target peak acquisition step of obtaining a plurality of adjustment target peaks by applying the peak model function stored in the storage part to the chromatogram; and
an adjustment target peak adjustment step of setting the adjustment target peak obtained in the adjustment target peak acquisition step as an initial value before adjustment, and repeating adjustment of the adjustment target peak until pseudo data of a three-dimensional chromatogram for the sample obtained by combining the adjustment target peaks after adjustment is similar to the actual data.

7. The data processing system according to claim 6, wherein the data processor is configured to use a function obtained by combining a Gaussian function and an exponential function as the peak model function.

8. The data processing system according to claim 6, wherein the data processor performs the adjustment using matrix decomposition in the adjustment target peak adjustment step.

9. The data processing system according to claim 8, wherein the matrix decomposition is a non-negative matrix factorization.

10. The data processing method according to claim 6, wherein in the adjustment target peak adjustment step, the data processor is configured to calculate degree of similarity between the pseudo data obtained by combining the adjustment target peaks after adjustment and the actual data, and to finish the adjustment when the degree of similarity satisfies a preset criterion or when the degree of similarity converges to a certain value.
